(19) United States
(12) Patent Application Publication
(10) Pub. No.: US 2009/0310846 A1
(43) Pub. Date: Dec. 17, 2009

(54) Apparatus and Method for Selectively Generating Graphic Medical Records from Continuous Multiplanar Viewing

(76) Inventor: Marc Lemchen, New York, NY (US)

Correspondence Address: Law Offices of Daniel L. Dawes;Dawes Patent Law Group, 5200 Warner Blvd, Ste. 106, Huntington Beach, CA, 92649, US

(21) Appl. No.: 12/486,689

(22) Filed: Jun. 17, 2009

Related U.S. Application Data
(60) Provisional application No. 61/073,257, filed on Jun. 17, 2008.

(51) Int. Cl. G06T 15/20; G06T 7/00

(52) U.S. Cl. 382/132; 345/427

(57) ABSTRACT

An apparatus and method for manipulating three dimensional image data. The apparatus takes each multiplanar view (MPR) obtained by a medical imaging device, such as an x-ray machine, of an area of the patient being examined and automatically “slices” the view in each direction sequentially. Each “slice” is then displayed to the user in order to make a running video. The user is allowed to stop the process when he or she sees the clearest view of the examined area of the patient and may save that image in a static computer record. Alternatively, the user may select to display a corresponding two dimensional x-ray image at that selected view. The user may then allow the video to continue to run and repeat the process for other selected views. The software automatically makes every relevant “slice” from every relevant view, allowing the user to stop, slow down, or back up when nearing a view which is desired to be studied or saved.

### RELATED APPLICATIONS

The present application is related to U.S. Provisional Patent Application, Ser. No. 61/073,257 filed on Jun. 17, 2008, which is incorporated herein by reference and to which priority is claimed pursuant to 35 USC 119.

### BACKGROUND OF THE INVENTION

1. Field of the Invention

The invention relates to the field of manipulating three dimensional image data, and in more particular selecting a desired area of a three dimensional image and sequentially “slicing” the image from a plurality of directions in order to make a running video.

2. Description of the Prior Art

Medical imaging techniques such as x-rays have long been used to diagnose and treat a whole variety of ailments and conditions. Many advancements in x-ray technology has allowed physicians and other treatment professionals to better address their patient's needs by continually providing higher and higher quality medical images, thus facilitating the detection and the beginning of the treatment process. While the medical images themselves have greatly improved over time, the methods of reviewing and manipulating those images have not.

Currently, when using computerized topographic data or any other type of three dimensional data obtained from a x-ray cone beam of a specific area of a patient's body, for example the teeth and jaw region, a dental practitioner looks at the different views of the teeth and jaw provided and then “slices” it or redirects the view in different directions to see areas of interest, i.e. the software provides a cross-sectional view of the x-ray image at a desired location. The computer software used to make these “slices” requires a certain amount of skill to use and therefore its full medical potential can only be realized when a trained technician or other professional with a preexisting knowledge of the software makes the “slices.” Recently, there have been efforts to make this software easier to use in order to make these “slices” more prevalent and part of the common medical treatment process, however further simplification is required.

### BRIEF SUMMARY OF THE INVENTION

What is disclosed in the current application is a method of selectively generating graphic medical records from a three dimensional database of a patient's anatomy stored in a computer comprising selecting a starting three dimensional data set representative of a starting view from the three dimensional data base, selecting a portion of the starting three dimensional data set within a defined window of viewing focus as displayed in a user selected starting view, automatically selecting a plurality of viewing axes, automatically varying the portion of the starting three dimensional data set which is selected within the defined window of viewing focus to produce smoothly sequenced successive portions of the three dimensional data set within the defined window of viewing focus along each one of the plurality of viewing axes as displayed in corresponding moving views, for each viewing axis, selectively stopping the production of smooth sequenced successive portions of the three dimensional data set within the defined window of viewing focus at a selected one of the smooth sequenced successive portions of the three dimensional data set in the defined window focus as displayed in a corresponding stopped view and for each viewing axis, selectively recording the selected one of the smooth sequenced successive portions of the three dimensional data set within the defined window of viewing focus as displayed in a corresponding recorded view.

The method further comprises for each viewing axis, rotating, translating or magnifying the selected portion of the three dimensional data set within the defined window of viewing focus prior to the recording of the selected portion of the three dimensional data set within the defined window of viewing focus as displayed in a corresponding rotated, translated or magnified view.

In another embodiment, the method further comprises for each viewing axis, resuming varying to completion the portion of the starting three dimensional data set defined within the defined window of viewing focus to produce smoothly sequenced successive portions of the three dimensional data set within the defined window of viewing focus as displayed in corresponding resumed moving views after recording the selected portion of the three dimensional data set within each viewing axis as displayed in the corresponding recorded view.

The method further comprises generating a two dimensional x-ray image for each viewing axis and selectively recording the generated x-ray image.

In another embodiment, the method above includes where selecting a starting three dimensional data set representative of a starting view comprises selecting a starting three dimensional data set representative of a starting view from a plurality of pre-determined starting three dimensional data sets, each corresponding to a different predetermined starting view.

In another embodiment, the method above includes where automatically selecting a plurality of viewing axes comprises automatically progressing though a sequence of pre-selected default viewing axes.

In yet another embodiment, the method above includes where automatically selecting a plurality of viewing axes comprises automatically progressing through a sequence of viewing axes as defined by a user.

In yet another embodiment, the method above includes where automatically selecting a plurality of viewing axes comprises automatically progressing through a sequence of randomly selected viewing axes.

In still yet another embodiment, the method above includes where selectively recording for each viewing axis the selected portion of the three dimensional data set within the defined window of viewing focus comprises recording the selected portion of the three dimensional data set within the defined window of viewing focus in an internal memory storage database within the computer or to an external and removable memory storage device.

In still yet another embodiment, the method above further comprises returning to the first viewing axis after the varying along each of the viewing axes have been completed and repeating the varying of each of the viewing axes in a continuous loop until stopped by a user.

The invention further includes an apparatus for selectively generating graphic medical records from a three dimensional database of a patient's anatomy stored in a computer comprising means for selecting a starting three dimensional data set representative of a starting view from the three dimensional database, means for selecting a portion of the starting three dimensional data set within a defined window of viewing focus for display in a corresponding starting view, means for automatically selecting a plurality of viewing axes, means for automatically varying the boundaries of the three dimensional data set within the defined window of viewing focus to produce smoothly sequenced contiguous portions of the three dimensional data set within the defined window of viewing focus along each one of the plurality of viewing axes for display in a corresponding moving view, for each viewing axis, means for selectively stopping varying the production of smooth sequenced contiguous portions of the three dimensional data set within the defined window of viewing focus at a selected one of the smoothed sequence of contiguous portions of the three dimensional data set within the defined window of viewing focus for display in a corresponding stopped view, and for each viewing axis, means for selectively recording the selected one of the smoothed sequence of contiguous portions of the three dimensional data set within the defined window of viewing focus for display in a corresponding recorded view.

The embodiment above further comprises for each viewing axis, means for rotating, translating or magnifying the selected portion of the three dimensional data set within the defined window of viewing focus prior to the recording of the selected portion of the three dimensional data set within the defined window of viewing focus for display in a corresponding rotated, translated or magnified view.

In another embodiment, the apparatus above further comprises for each viewing axis, means for resuming varying to completion the portion of the starting three dimensional data set defined within the defined window of viewing focus to produce smoothly sequenced successive portions of the three dimensional data set within the defined window of viewing focus for display in corresponding resumed moving views after recording the selected portion of the three dimensional data set within the defined window of viewing focus.

In another embodiment, the apparatus above further comprises means for generating a two dimensional x-ray image for each viewing axis and means for selectively recording the generated x-ray image.

In yet another embodiment, the apparatus above includes where the means for selecting a starting three dimensional data set representative of a starting view from the three dimensional database comprises means for selecting a starting three dimensional data set representative of a starting view from a plurality of pre-determined starting three dimensional data sets, each corresponding to a different predetermined starting view.

In yet another embodiment, the apparatus above includes where the means for automatically selecting a plurality of viewing axes comprises means for automatically progressing though a sequence of pre-selected default viewing axes.

In still yet another embodiment, the apparatus above includes where the means for automatically selecting a plurality of viewing axes comprises means for automatically progressing through a sequence of viewing axes as defined by a user.

In still yet another embodiment, the apparatus above includes where the means for automatically selecting a plurality of viewing axes comprises means for automatically progressing through a sequence of randomly selected viewing axes.

The apparatus above further comprises where for each viewing axis, the means for selectively recording the selected portion of the data set within the defined window of viewing focus comprises an internal memory or an external and removable memory device capable of recording a selected portion of the data set within the defined window of viewing focus and recorded instructions for controlling a computer to render the selected portion of the data set into the corresponding recorded display.

Finally, the apparatus above further comprised means for returning to the first viewing axis after the varying of each of the viewing axes have been completed and means for repeating the varying of each of the viewing axes in a continuous loop until stopped by a user.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is an example of a computer screen image of the program module depicting four simultaneous starting defined windows of the three dimensional image data.

FIG. 2 is an example of a computer screen image of the program module depicting four simultaneous starting windows of the three dimensional image data after a selection window has been chosen by the user.

FIG. 3 is an example of a computer screen image of the program module depicting four simultaneous starting windows of the three dimensional image data after a selection window has been chosen and re-sized by the user.

FIG. 4 is a magnified example of a computer screen image of the program module depicting a starting window of the three dimensional image data after the selection window has been chosen and magnified by the user.

FIG. 5 is a magnified example of the tool bar used in the program module to change and alter the starting and selection windows as desired by the user.

FIG. 6 is an example screenshot of the software module depicting the beginning of a three dimensional sagittal slice progression.

FIG. 7 is an example screenshot of the software module depicting an intermediate step of a three dimensional sagittal slice progression.

FIG. 8 is an example screenshot of the software module depicting a final step of a three dimensional sagittal slice progression.

FIG. 9 is an example screenshot of the software module depicting a two dimensional x-ray image that has been built from the corresponding three dimensional data depicted in FIG. 7.

FIG. 10 is an example screenshot of the software module depicting a two dimensional x-ray image that has been built from the corresponding three dimensional data depicted in FIG. 8.

FIG. 11 is an example screenshot of the software module depicting a two dimensional x-ray image that has been built from the corresponding three dimensional data depicted in FIG. 9.

FIG. 12 is an example screenshot of the software module depicting the beginning of a three dimensional coronal slice progression.

FIG. 13 is an example screenshot of the software module depicting an intermediate step of a three dimensional coronal slice progression.

FIG. 14 is an example screenshot of the software module depicting a final step of a three dimensional coronal slice progression.

FIG. 15 is an example screenshot of the software module depicting a two dimensional x-ray image that has been built from the corresponding three dimensional data depicted in FIG. 12.

FIG. 16 is an example screenshot of the software module depicting a two dimensional x-ray image that has been built from the corresponding three dimensional data depicted in FIG. 13.

FIG. 17 is an example screenshot of the software module depicting a two dimensional x-ray image that has been built from the corresponding three dimensional data depicted in FIG. 14.

FIG. 18 is an example screenshot of the software module depicting the beginning of a three dimensional axial slice progression.

FIG. 19 is an example screenshot of the software module depicting an intermediate step of a three dimensional axial slice progression.

FIG. 20 is an example screenshot of the software module depicting a final step of a three dimensional axial slice progression.

FIG. 21 is an example screenshot of the software module depicting a two dimensional x-ray image that has been built from the corresponding three dimensional data depicted in FIG. 18.

FIG. 22 is an example screenshot of the software module depicting a two dimensional x-ray image that has been built from the corresponding three dimensional data depicted in FIG. 19.

FIG. 23 is an example screenshot of the software module depicting a two dimensional x-ray image that has been built from the corresponding three dimensional data depicted in FIG. 20.

FIG. 24 is an example screenshot of the software module depicting the orientation calibration screen.

FIG. 25 is an example screenshot of the software module depicting the build x-rays tool screen with the lateral x-ray view selected.

FIG. 26 is an example screenshot of the software module depicting the build x-rays tool screen with the panoramic x-ray view selected.

FIG. 27 is an example screenshot of the software module depicting the build x-rays tool screen with the TMJ x-ray view selected.

FIG. 28 is an example screenshot of the software module depicting the build x-rays tool screen with the cross sections x-ray view selected.

FIG. 29 is an example screenshot of the software module depicting the build x-rays tool screen with the nerve canals x-ray view selected.

FIG. 30 is an example screenshot of the software module depicting the build x-rays tool screen with the frontal x-ray view selected.

FIG. 31 is an example screenshot of the software module depicting the build x-rays tool screen with the SMV x-ray view selected.

FIG. 32 is an example screenshot of the software module depicting the sinus/airway screen.

FIG. 33 is an example screenshot of the software module depicting the superimposition screen.

FIG. 34 is an example screenshot of the software module depicting the 3D script editor screen.

FIG. 35 is an example screenshot of the software module depicting the mirroring tool screen.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The invention relates to an apparatus and method for manipulating three dimensional image data. In the illustrated embodiment of the invention each multiplanar view (MPR) is obtained by a medical imaging device, such as an x-ray machine, of an area of the patient being examined and the images stored in a three dimensional database of the medical imaging device are automatically “sliced” into a series of selected three dimensional views in each direction sequentially. Each “slice” is then displayed to the user in an overlapping sequence to make a running video or a series of three dimensional subviews generated from the stored three dimensional database moving or rotating in an user-defined direction in three dimensional space. The user is allowed to stop the process when he or she sees, in the judgment of the viewer, the clearest, desired, or best selected three dimensional view of the examined area of the patient and that image is then saved as either a static three dimensional color view or a traditional black and white x-ray image in a computer record. The user may then allow the video to continue to run and repeat the process for other selected views in the same or different directions as may be variously chosen or defined by the viewer. The viewer needs no particular skills in using the editing or slicing features of the software beyond indicating an area of interest or target area and the direction in which the sequential views shall be taken. The software automatically makes every relevant “slice” from every relevant viewing sequence, allowing the user to stop or slow down the rate of sequencing when nearing a view which is desired to be studied or saved. The fineness or distance between the slices in a sequence of views may be taken with a default value or chosen/defined by the viewer. With a minimal amount of skill with the program, the user may select only specific views to be “sliced” or use a preselected plurality of default sequences and directions that have been pre-programmed into the software as defaults.

While it is disclosed that the current invention may be used in examining the teeth and jaw region of a patient by a dental practitioner, this is only an example of the use of the current invention and it is meant to be for illustrative purposes only. It is to be expressly understood that other regions or bone groups of the patient may be examined by their respective qualified professionals using the invention disclosed herein without departing from the original spirit and scope of the invention.

As an example, the user may take a lateral sagittal three dimensional image that has been taken or provided to the user by a medical imaging device and put a circle or other icon (like a magnifying glass) over the area of interest. The user then “clicks and drags” the icon over the lateral image and watches that selected portion of the three dimensional image data effectively change into a video image as the computer then runs a series of “slices” or restricted view windows in each direction. The user may stop the progression of the video on those three dimensional views or images he or she wants to freeze-frame and save. After saving the image, the user may resume the slicing, rewind the slicing process to a previously shown image, or alternatively change the angle in which the slices are taken from. Additionally, with the three dimensional image progression stopped, the user may then switch the image from a three dimensional color image to a two dimensional black and white x-ray image. A static x-ray image may be obtained from any point in the three dimensional image progression, regardless of angle, or depth of the three dimensional image. The x-ray image may then be saved to a computer database for further use, or the image may be changed back to a three dimensional image and then the progression may be resumed or re-started.

Furthermore, the user might desire to then look at the same three dimensional data set but from a different viewpoint or viewing axis, such as an axial view, a coronal view, or any other arbitrary selected viewing axis. After selecting another starting viewing axis, the user again picks an area for focus by “clicking and dragging” on the specific area of interest and then the process of running through the three dimensional slices or subwindows of that area is repeated. If the user does not see the image that he is looking for, the computer then automatically chooses another starting viewing axis and then progresses with another series of corresponding slices. This process may be repeated automatically for any selected starting viewing axis or for any desired sequence of angles for as many times as the user desires or deems necessary.

After a specific area of a starting view has been selected, the computer software “slices” the remaining views of the image data sequentially and automatically, eventually going through a complete sequence of views through a chosen axis and thus completing a chosen progression of the image data. The views through which the computer software slices may further be restricted by the user by pre-selecting only specific starting views of the targeted area to be sliced. The “slicing” sequence is automatic and is repeatable for each area of interest the user selects within each starting viewing axis. Alternatively, the user may choose to slice through a sequence of orientation angles about a selected axis of rotation.

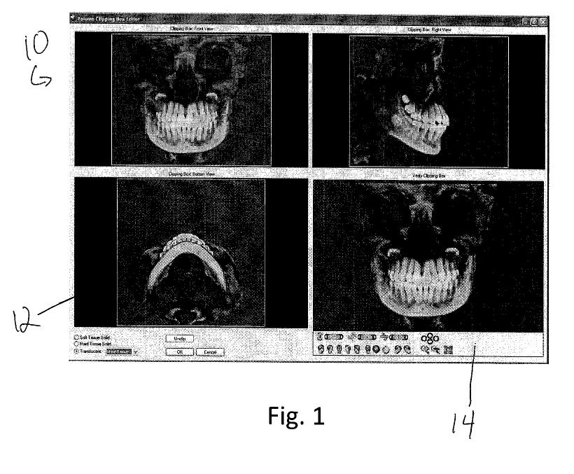

Turning now to FIG. 1, the figure illustrates three typical views taken from an x-ray cone beam computerized topographic data set stored within the main program module, which three dimensional views are generally noted by reference numeral 10. Each view is displayed within a starting window 12. For illustration purposes, three starting windows 12 have been shown in FIG. 1, however fewer or more than three windows may be used without departing from the original spirit and scope of the invention. The main program module 10 also comprises at least one tool bar 14 for manipulating the image data within each selected starting window 12, one of which is shown as chosen and displayed in the working window. The views are obtained by a medical imaging device as is well known in the art.

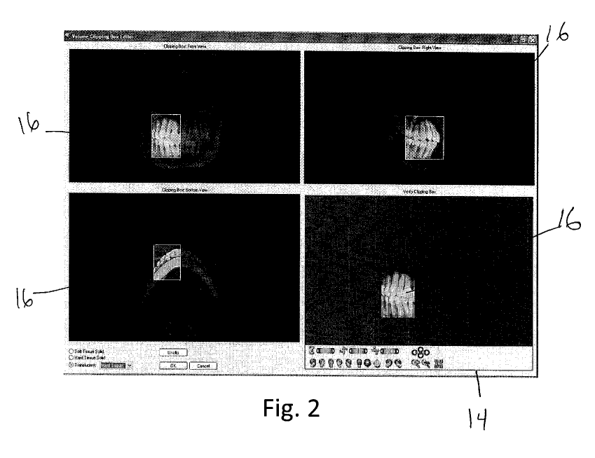

The first step in manipulating the image data is for the user to select that portion of each starting stationary view which is of interest to the user for closer or future viewing and possible selection for data archiving. As shown in FIG. 2, a rectangular selection window 16 of each of the three starting windows 12 has been manually selected and highlighted. Thus a three dimensional subspace of the entire three dimensional database has been selected for slicing and possible freeze-frame selection and storage. In FIG. 2 the selection window 16 is shown in sagittal, axial, and coronal views simultaneously, however it is to be expressly understood that fewer or additional views or perspectives may be used without departing from the original spirit and scope of the invention.

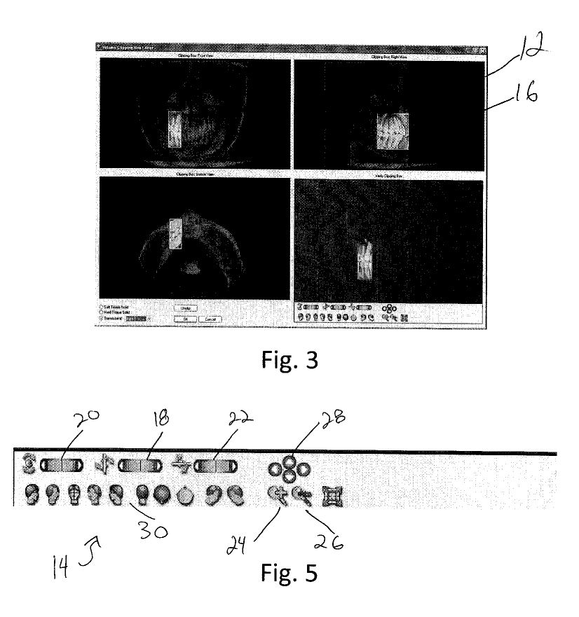

Once an area of interest has been chosen within the starting windows 12, the user can move any side of the selection window 16 in any direction to see or select different views of the data as shown in FIG. 3. The selection window 16 is put into motion in a direction according to user choice so that the view provided by the selected data set is smoothly rotated and/or linearly moved as if the object was actually being rotated and/or moved on a platform. In one embodiment, the object rotates and/or moves only within the selection window 16 and sequentially shows a series of connected views on a path of travel. The motion can be stopped by the user at any time using toolbar 14 and a static snapshot of the data can be taken for archival. The movement within the selection window 16 may then be restarted where it previously left off.

For example, as shown in FIG. 3 a starting window 12 which represents a starting viewing axis of the teeth and jaw can be selected and rotated to show the right lateral side. This starting window 12 is then fixed throughout the process. A selection window 16 is then chosen by the user to highlight an area of the molars. When the program is set to run, the viewpoint or position of the starting window 12 remains stationary and continues to provide the user of a point of view or viewing axis of the teeth and jaw from the right lateral side while the displayed “slices” of the skull and jaw then begin to smoothly run like a motion picture beginning with the teeth on the right lateral side and progressing further toward the front of the jaw. The motion picture continues eventually showing the front teeth passing in the view of the selection window 16 and then finally the left lateral teeth as it moves from the front to the back of the molars, all still from the position or viewpoint of the original right lateral side of the jaw.

The motion is of course relative, so that the process could be equivalently described as having the skull and jaw in a dynamic position by coupling the starting window 12 to the selection window 16 so that when the selection window 16 moves smoothly around the jaw as in a panoramic viewing of the exterior surface of the teeth and jaw moving from the right side molars all the way around to the left side molars, the starting window 12 follows accordingly.

Alternatively, the starting window 12 may be changed to the user's desire at any time during the “slicing” process. For example, the starting window 12 may at first remain stationary in the right lateral position as the selection window 16 continues to “slice” and move through the image data from the right lateral position to the front of the jaw. Once reaching the front of the jaw, the “slicing” may be stopped and the starting window 12 may then be rotated to “catch up” with the selection window 16 so that the view in both the starting window 12 and selection window 16 is the same front viewing position where the sequence was stopped. When the “slicing” is restarted, the starting window 12 may then remain stationary again from the front perspective view of the jaw as the selection window 16 continues to show progressive “slices” as it continues its pan around the jaw and finally stopping at the left lateral position.

Furthermore, program module 10 may show a plurality of starting views 16 with a plurality of selection windows 16 as shown in FIG. 3 so as to provide multiple simultaneous perspectives of the same patient's jaw as the image data is being “sliced”, each viewing from a different viewing axis. Each starting window 12 may be independently manipulated, i.e. each selection window 16 corresponding to a particular starting window 12 may be stopped, the freeze-framed imaged saved to an archive (not shown), the starting window 12 rotated to a new viewing axis, and then the selection window 16 reset to continue “slicing” the image data in a predetermined direction.

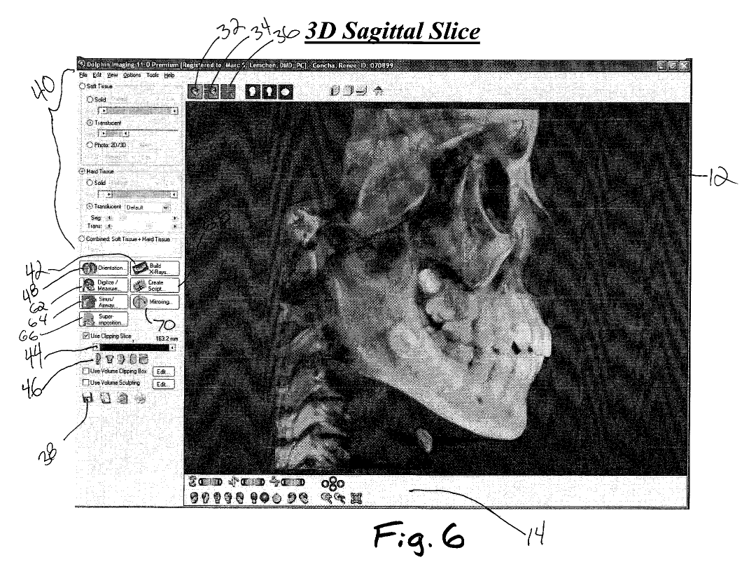

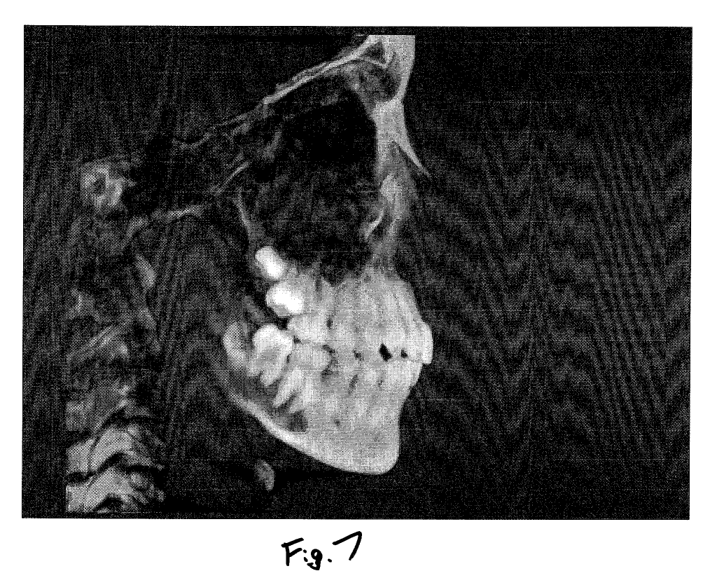

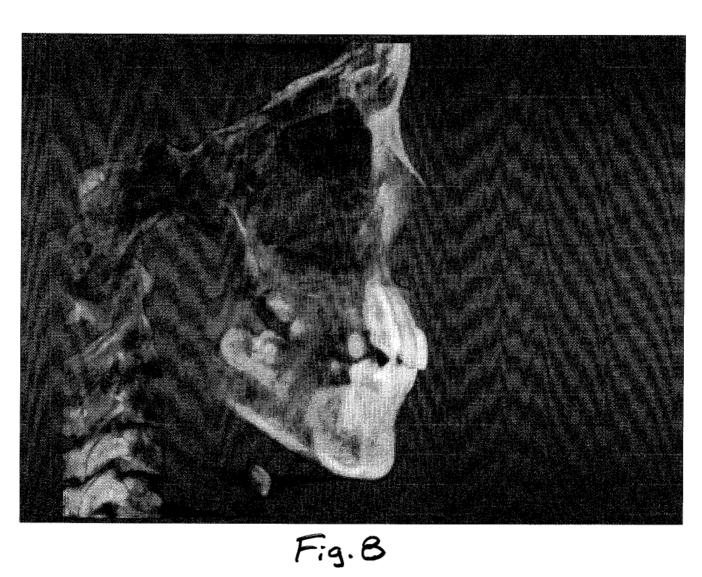

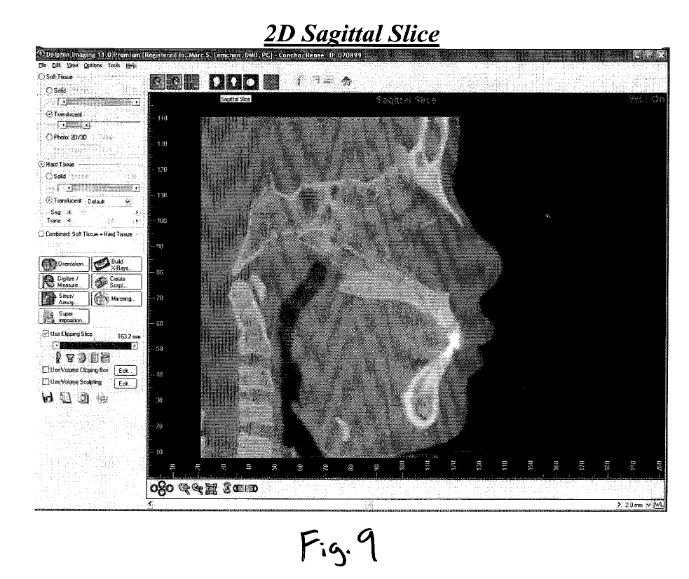

Turning now to FIG. 6, assume that a viewing axis on the right lateral of the jaw is chosen and to display the buccal surfaces of the teeth on the right side of the jaw from the molars to the front upper and lower teeth. The image window or the plane of the three dimensional view, taken to be perpendicular to the direction of view, and which plane is generally parallel to the side of the jaw, is then moved inwardly on the viewer's command along a line of direction perpendicularly across the jaw keeping the viewpoint fixed from the right side of the jaw. As seen in FIG. 7, because of the curvature of the jaw, the three dimensional view of the teeth progressively begins to disappear as each sequential “slice” is passed through by the image plane. Thus, the rear portion of the jaw and then the molars begin to disappear as the viewing plane continues to move forward, revealing a different and deeper planar three dimensional view of the teeth as the image plane is translated laterally across the jaw and deeper into the mouth. The layers of x-ray data continue to disappear, revealing newer three dimensional views of the teeth as the plane of view continues to move deeper past the molars and to the incisors and front teeth as depicted in FIG. 8. Thus, it can be understood that a progression of three dimensional images are displayed in front of the moving image plane or window as seen from the selected fixed viewing axis.

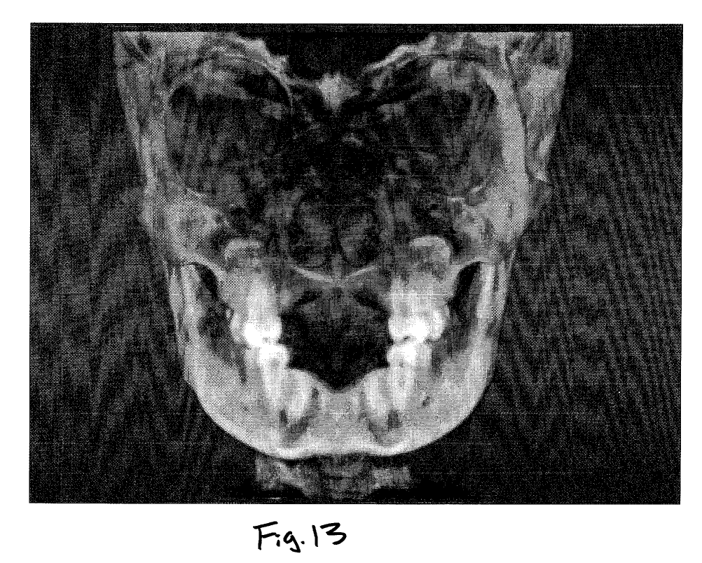

It is important to note that the fixed starting viewing axis and image plane or window can be varied in direction and position or the direction of the viewing axis rotated at any time during the viewing process, and that the motion of the image plane or window can be varied or changed in any direction of linear motion during the viewing process. For example, similar image manipulations are carried for coronal and axial views in FIGS. 12-14 and FIGS. 18-20 respectively.

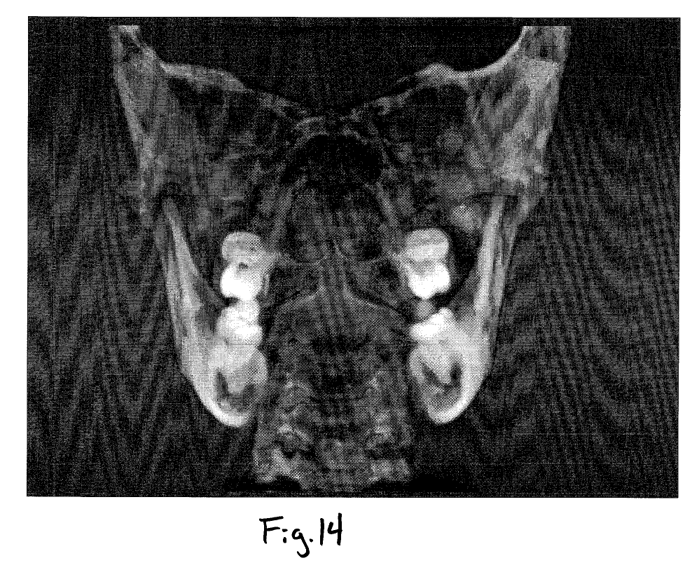

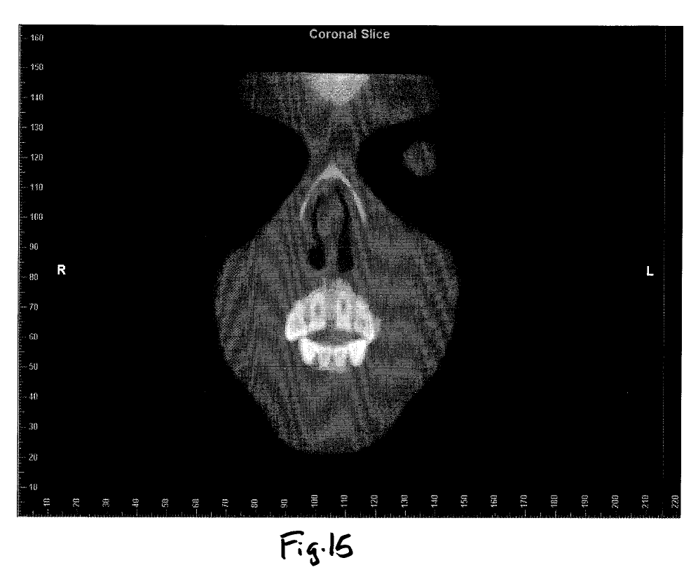

In FIG. 12, assume that a viewing axis of the frontal portion of the jaw is chosen to display the front surfaces of the teeth on the jaw from the upper and lower central incisors to approximately the upper and lower second bicuspids. The image window or the plane of the three dimensional view, taken to be perpendicular to the direction of view, and which plane is generally parallel to the front of the jaw, is then moved inwardly at the viewer's command along a line of direction perpendicularly across the front of the jaw keeping the viewing axis fixed from the front of the jaw. As seen in FIG. 13, because of the curvature of the jaw, the three dimensional view of the teeth progressively begins to disappear as each sequential “slice” is passed through by the image plane. Thus, the frontal portion of the jaw including the chin and then the upper and lower anterior teeth begin to disappear as the viewing plane continues to move forward, revealing a different and deeper planar three dimensional view of the teeth as the image plane is translated across the jaw from front to back and deeper into the mouth. The layers of x-ray data continue to disappear, revealing newer three dimensional views of the teeth as the plane of view continues to move deeper past the molars as depicted in FIG. 14.

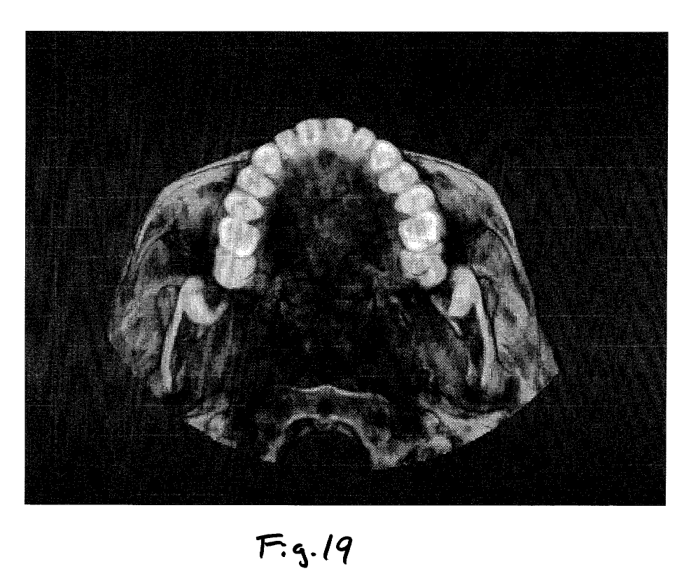

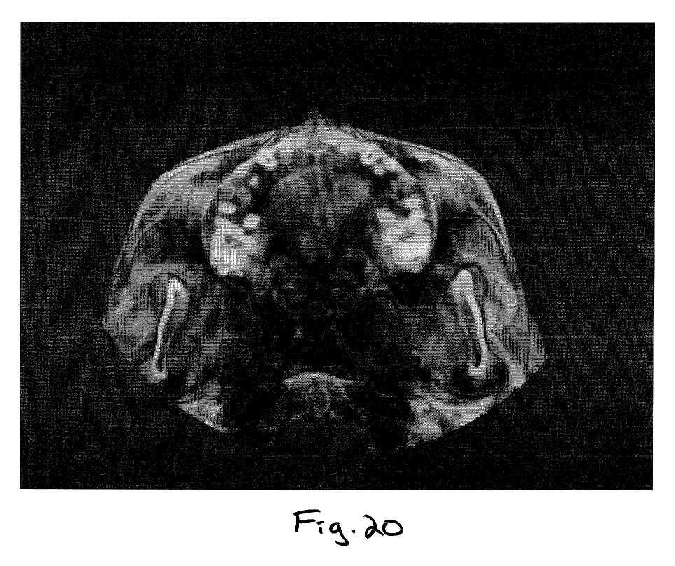

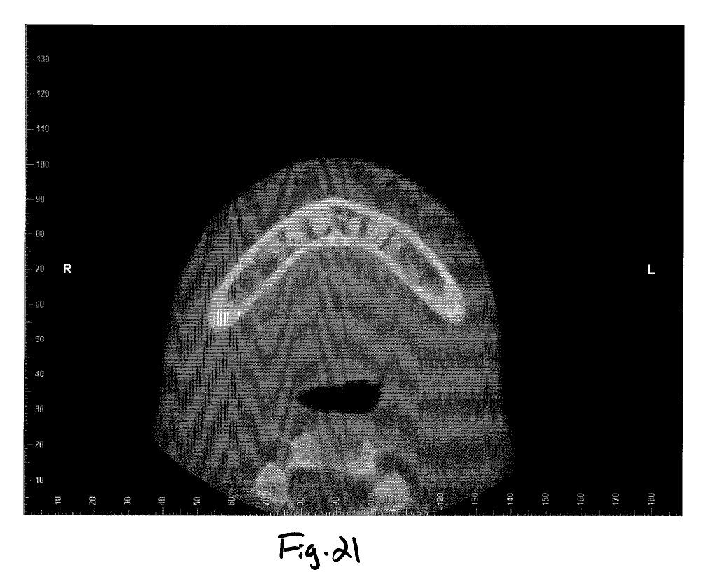

In FIG. 18, assume that a viewing axis of the frontal portion of the jaw from beneath the jaw looking upward is chosen to display the lower axial surfaces of the teeth on the jaw from the central incisors to approximately the second bicuspids. The image window or the plane of the three dimensional view, taken to be perpendicular to the direction of view, and which plane is generally parallel to the bottom of the jaw, is then moved inwardly at the viewer's command along a line of direction perpendicularly upward across the front of the jaw keeping the viewing axis fixed from beneath the jaw. As seen in FIG. 19, because of the curvature of the jaw, the three dimensional view of the teeth progressively begins to disappear as each sequential “slice” is passed through by the image plane. Thus, the frontal portion of the jaw including the chin and then the lower teeth begin to disappear as the viewing plane continues to move forward, revealing a different and deeper planar three dimensional axial view of the upper teeth as the image plane is translated upward across the jaw and deeper into the mouth. The layers of x-ray data continue to disappear, revealing newer three dimensional views of the teeth as the plane of view continues to move deeper past the outer axial surfaces of the upper teeth as depicted in FIG. 20.

It is to be expressly understood that the three image progressions detailed above are for illustrative purposes only and that any arbitrary starting viewing axis may be selected and ran through in a similar fashion.

It is further an embodiment of the invention that when the computer has finished slicing through the image data set from a first selected starting viewing axis, the computer will then automatically and without any manipulation on the part of the user, switch to a new starting viewing axis and repeat the slicing process. The computer may be configured to sequentially go through any number of pre-selected or viewer defined viewing axes. For example, the computer after completely progressing through the image data set as shown in FIG. 6-8, may then automatically switch to a coronal viewing axis and then begin to slice the image data as shown in FIGS. 12-14. If after progressing through the entire series of viewing axes, the user has not seen the image they were looking for, the computer automatically starts over at the first starting viewing axis that was first sliced and repeats the slicing image progression from the beginning. If left alone, the computer will automatically and continuously cycle through the plurality of viewing axes, thus forming a continuous loop for the user to view. The loop continues to repeat itself until stopped by a user.

The user may run a slicing progression on a particular data set from a plurality of pre-selected starting viewing axes such as sagittal, coronal, and axial as discussed above, however any orientation for the starting viewing axis may be chosen or defined by the user. For example, the user may choose to pick any number of arbitrary or random viewing axes to automatically cycle, or alternatively, a more methodical viewing axis progression may be defined such as rotating about the x-axis at 5 degree intervals between each starting view progression.

The computer's ability to automatically cycle through each viewing axis allows the user to view the x-ray images of an area of interest at multiple angles with minimal user input. This not only increases the efficiency of image data viewing, but allows users with only basic computer skills to take advantage of computer image manipulation which has been up to this point very user intensive.

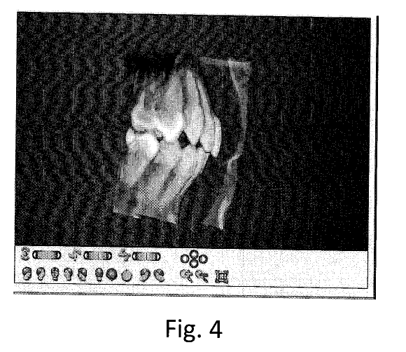

In addition to defining the starting views as disclosed above, the user may stop each image progression mid-stream and change the viewing axis at any time. The user manipulates the image data as discussed above by using an orientation bar 14 that is included in the program module 10 and shown in detail in FIG. 5. The user can rotate the image data circularly about the z-axis with a circular rotation icon button 20, about the y-axis with a horizontal rotation icon button 18, and about the x-axis with a vertical rotation icon button 22 or an arbitrary combination of all three axes. The image data may also be zoomed in on as is shown in FIG. 4 with a zoom-in icon button 24, and zoomed out on with a zoom-out icon button 26. The selection window 16 may be moved around the image data within the starting window 12 by either pointing and clicking or clicking and dragging the selection window 16 manually with a mouse (not shown). Alternatively, the selection window 16 may be moved about the image data using a set of directional icon buttons 28.

Additionally, the viewer may change the number and orientation of starting windows 12 which are displayed by the module 10 at one time by selecting one of a plurality of display icons 32, 34, 36 located near the top of the module 10 as depicted in FIG. 6. The full image display icon 32 makes the module 10 display a single starting window 12 for the viewer to manipulate as seen in FIG. 6. The highlighted image display icon 34 makes the module 10 display the selected starting window 12 as the largest window for the viewer to manipulate while still maintaining up to three additional starting windows 12 in a smaller size along outer edges of the module 10. The quarter display icon 36 displays all of the starting windows 12 including the starting window that is being manipulated in four equal sizes as shown in FIGS. 1-3.

In addition to the method of manipulating the image data as described above, the user may also change each starting window 12 to a preselected viewing axis with a plurality of orientation icon buttons 30. At any time during the manipulation of the data image, the perspective of any starting window 12 may be instantly returned to the viewing axis of the selected orientation icon button 30. The number and orientation of each orientation icon button 30 as shown in FIG. 5 is for illustrative purposes only and it is to be expressly understood that fewer or additional orientation icon buttons 30 may be employed without departing from the original spirit and scope of the invention.

Further manipulation of the three dimensional data set as discussed above may be done by the viewer at any point during the manipulation by selecting to view a traditional two dimensional black and white x-ray image of the current color three dimensional image being displayed. For example, in order to get a starting reference point the viewer may wish to display an x-ray image of the starting position shown in FIG. 6.

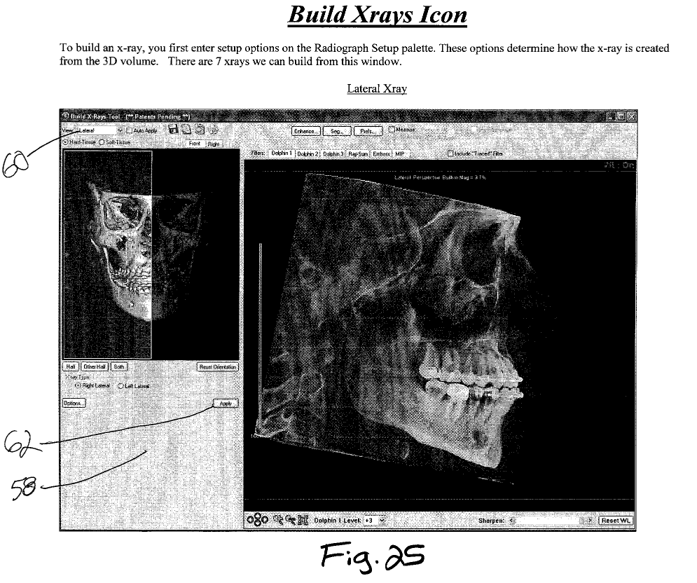

To do so, the viewer must first orient the three dimensional volume data so that the x-rays are created correctly. The viewer first selects an “Orientation” icon 48 on the left side of the module 10 as seen in FIG. 6 which brings up the orientation calibration screen 50 shown in FIG. 24. Here the viewer rotates the three dimensional volume using the rotational icons 18, 20, 22 and shifts the three dimensional volume using the directional icon buttons 28 until it is correctly orientated with the axial plane line 52 and the mid sagittal plane line 54 firmly in the center of the three dimensional image. In FIG. 24 the frontal view of the three dimensional volume is shown however other orientations may be selected and then orientated using the orientation selection icons 56 located above the image. Once the viewer is satisfied with the orientation of the three dimensional image, an “OK” button 58 is selected and the orientation is saved to the database and the module 10 returns to the view seen in FIG. 6.

With the proper orientation in place, x-rays may now be built from the three dimensional volume. First, the viewer enters a series of setup options on a radiograph setup palette 40 shown in FIG. 6. Here the viewer selects what type of tissue has been x-rayed, namely soft tissue, hard tissue, or a combination of soft and hard tissue. In FIG. 6, since it is desired to view x-ray images of teeth, hard tissue has been selected. The viewer then selects at what depth of the three dimensional image displayed in the starting window 12 the x-ray image is taken from. The viewer may select the depth of the displayed x-ray from an adjustable clipping slice tool bar 44, or alternatively, from a plurality of pre-determined depths such as the sagittal, coronal, and axial midpoints via a plurality of corresponding depth icons 46. For the purposes of illustration, the clipping slice tool bar 44 has been set to display an x-ray image of the corresponding three dimensional image at the sagittal midpoint.

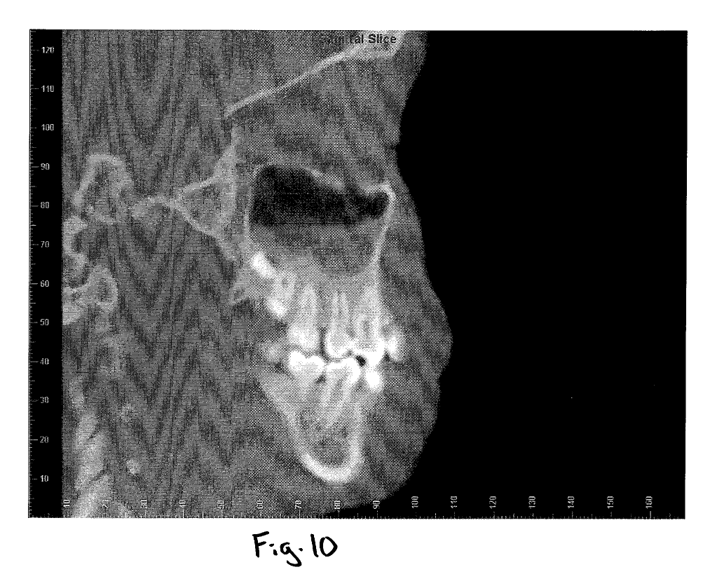

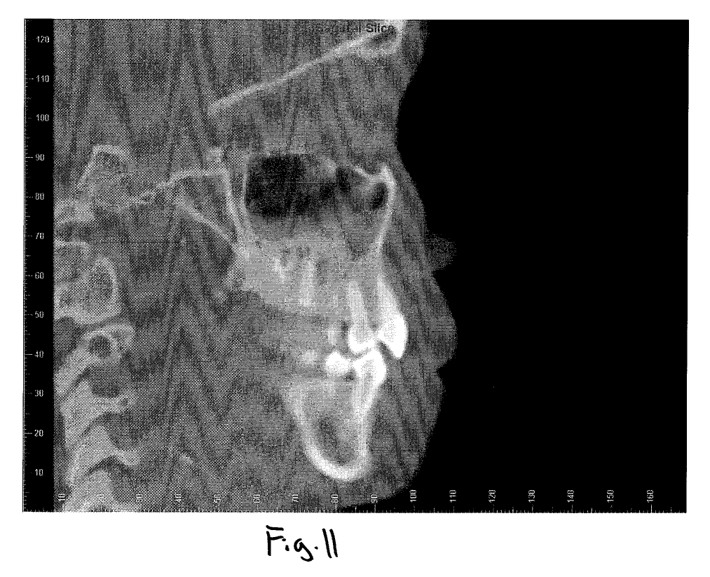

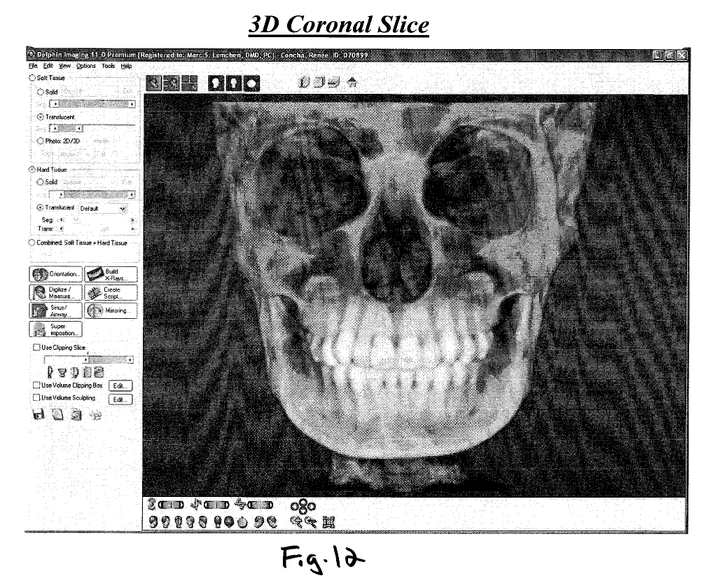

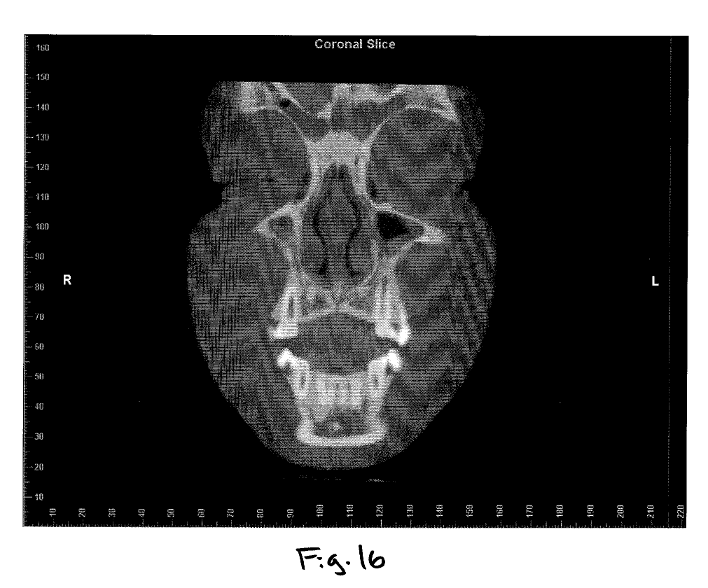

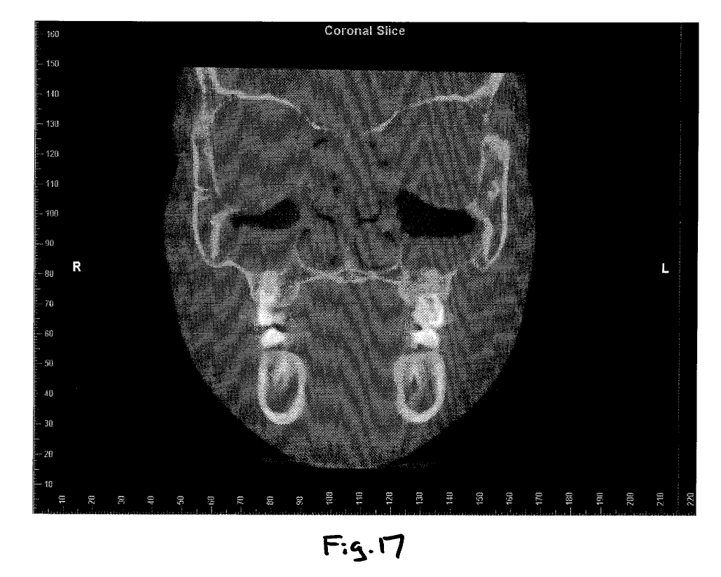

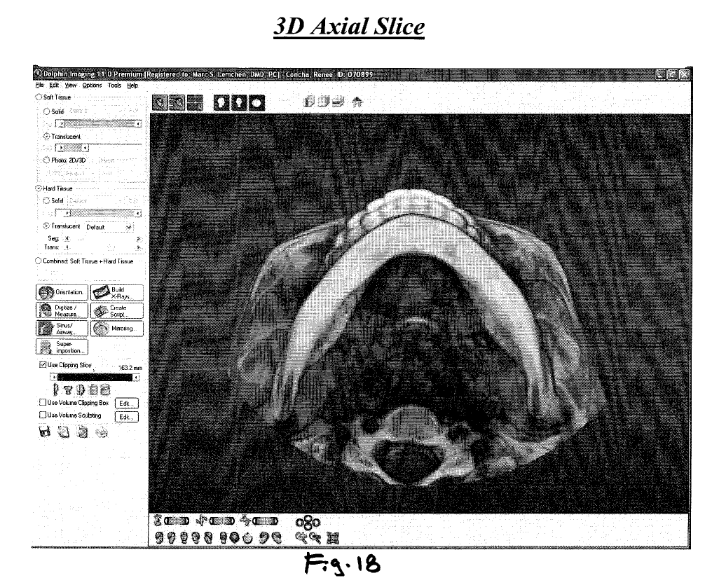

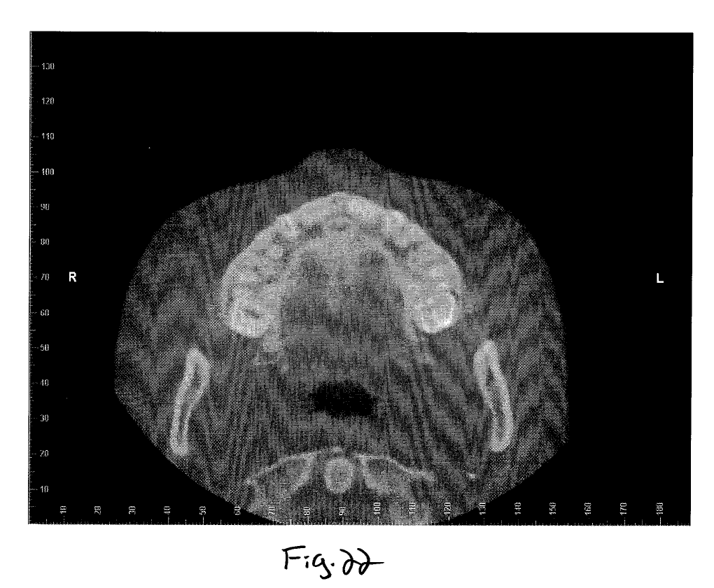

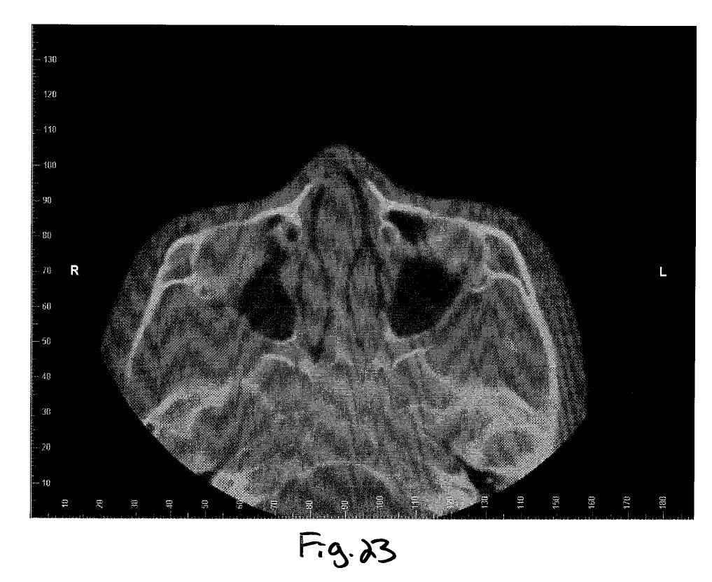

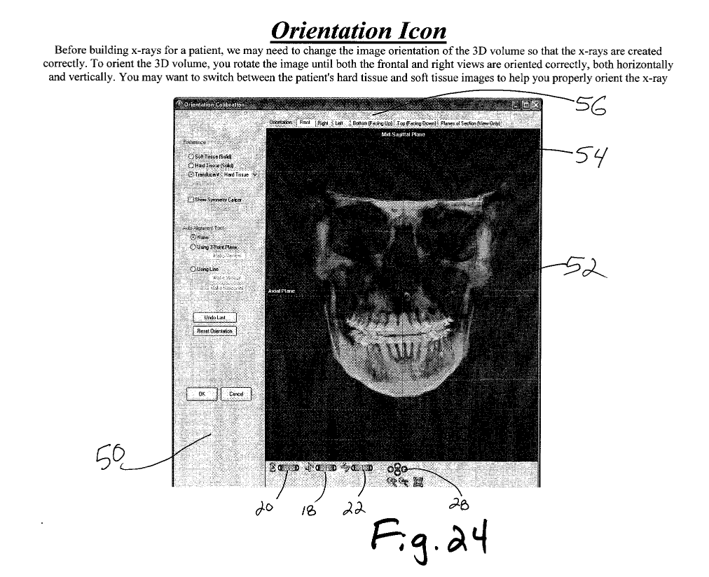

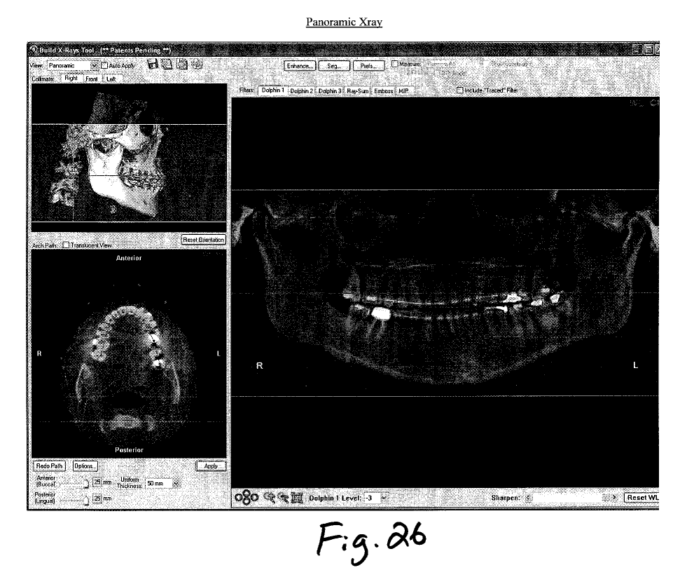

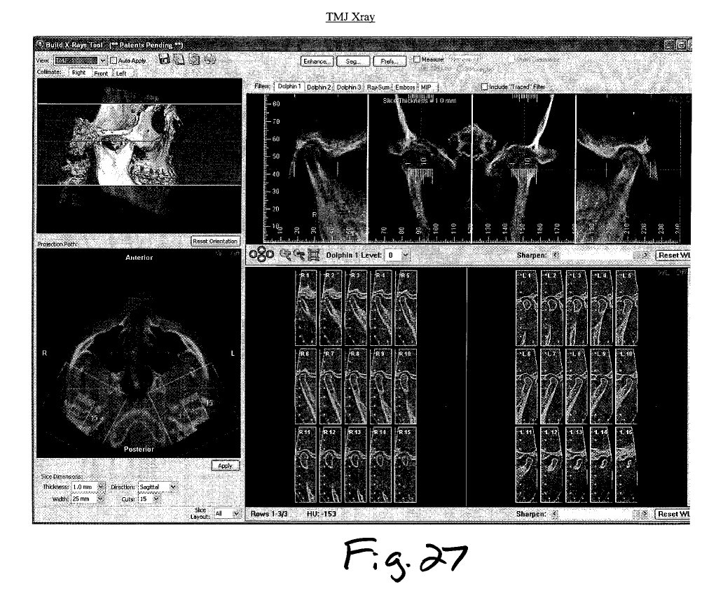

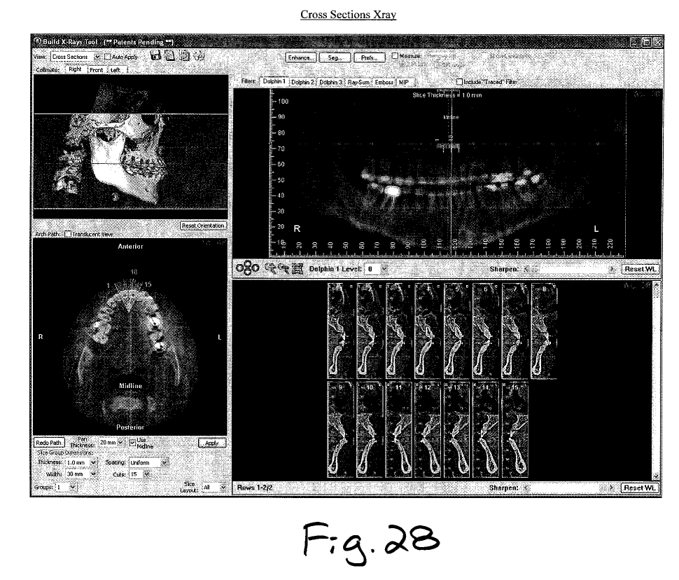

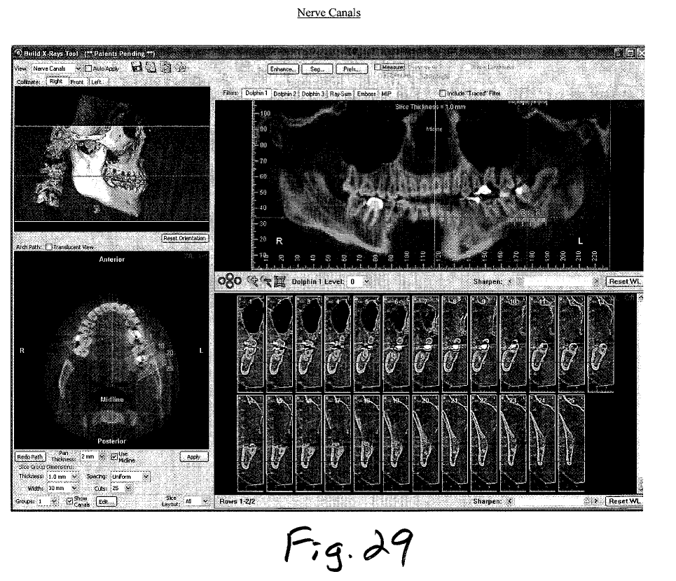

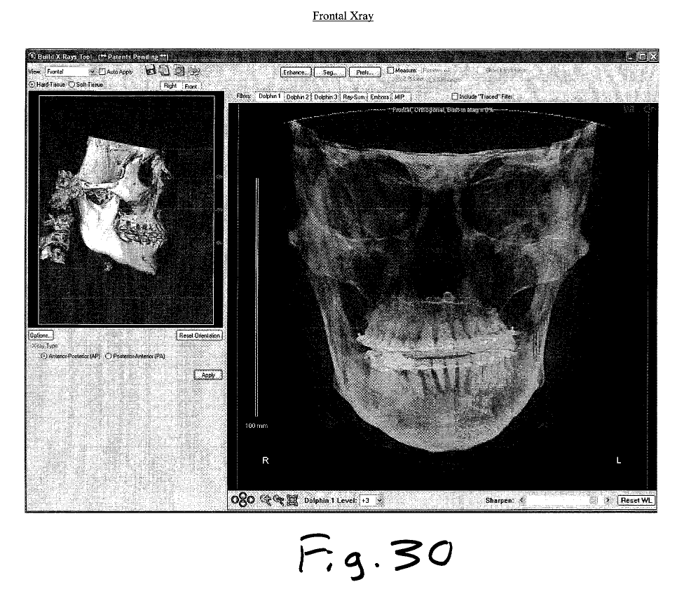

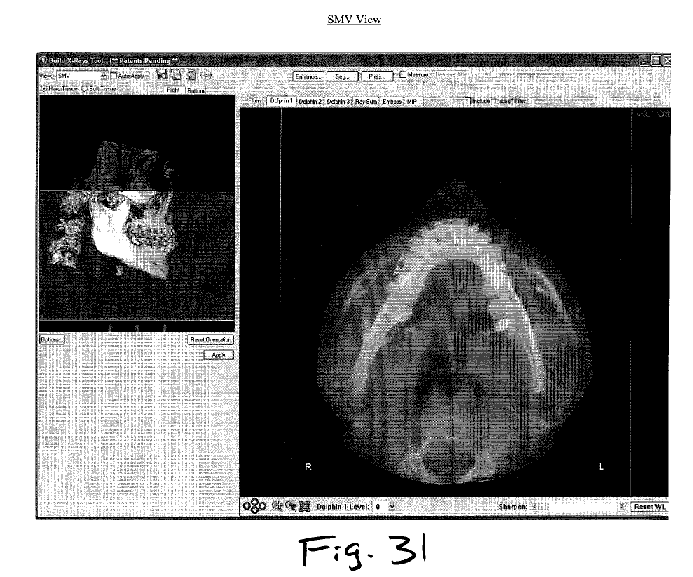

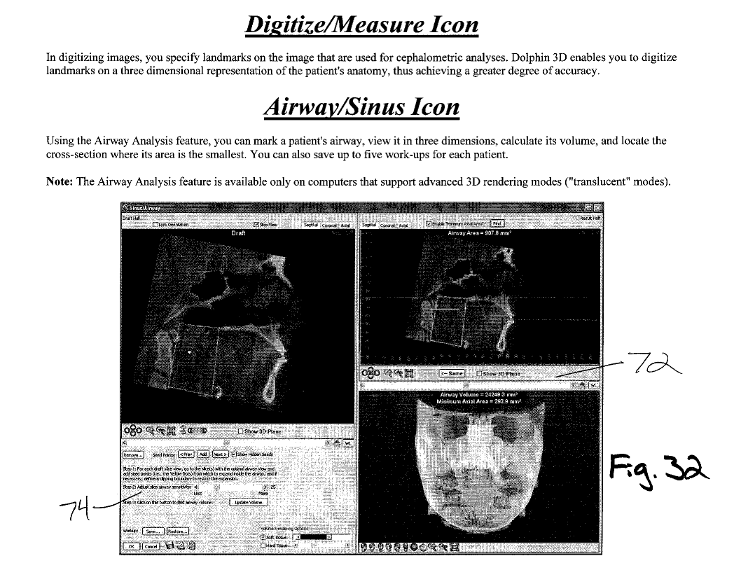

Once all of the x-rays options have been selected, the viewer selects a “Build X-Rays” icon 42 and a build x-rays tool screen 58 is displayed on the * module 10 as seen in FIG. 25. Here the viewer may select what type of x-ray is built using the view drop-down menu 60 located in the upper left corner of the x-rays tool screen 58. In FIG. 25 the lateral x-ray view is chosen, however a plurality of different views and types of x-rays may be made including panoramic in FIG. 26, TMJ in FIG. 27, cross sections in FIG. 28, nerve canals in FIG. 29, frontal in FIG. 30, and SMV in FIG. 31. Returning to FIG. 25, with the desired type of x-ray selected, the viewer selects an “Apply” button 62 and a two dimensional x-ray image corresponding to the selected x-ray view and options previously entered by the viewer is then displayed across the module 10 as seen in FIG. 9. This process may be repeated as many times as desired for any number of views, angles, or x-ray depths. As an example, FIGS. 10 and 11 depict two dimensional x-ray images that have been built to correspond to the three dimensional images shown in FIGS. 7 and 8 respectively. Similarly, for each step in the coronal progression shown in FIGS. 12-14, FIGS. 15-17 show a corresponding two dimensional x-ray image that may be built. Finally, for each step in the axial progression shown in FIGS. 18-20, FIGS. 21-23 show a corresponding two dimensional x-ray image that may be built. These examples are for illustrative purposes only and it should be explicitly understood that any number of images within any arbitrary image progression may be used to build an x-ray image as described above.

Once the user is satisfied with the built two dimensional x-ray image, he or she can selectively record or save the images individually as a snapshot. The user records the snapshot images to an archive (not shown) by selecting the save icon 38 shown in FIG. 6. The archive may be an internal memory device or database stored within the computer in which program module 10 is being operated, or alternatively the image may be recorded to an external memory device such as a flash drive or compact disc. Alternatively, the external memory device may also store a set of pre-recorded or pre-programmed instructions on it. The instructions stored on the memory device instruct the user as to the operation and procedure of working with the above disclosed computer software module in an efficient manner, thus increasing ease of use and productivity for new users and users who may already have some experience with other image data software programs.

After the two dimensional x-ray image has been viewed or saved, the module 10 may then be switched back to a display of the original three dimensional volume. At this point, the slice progression process described above may be restarted or resumed, or alternatively an entirely new progression may be established and the entire process repeated.

It is further an embodiment of the invention to provide a variety of other useful features related to orthodontic work besides the manipulation of the three dimensional volumes and the building of x-rays from those three dimensional manipulations. Turning back to FIG. 6, a “Digitize/Measure” icon button is selected when cephalometric analysis of the three dimensional volume is desired. Once selected, the module 10 digitizes the images and allows the user to specify landmarks on the image, thus achieving a greater degree of accuracy.

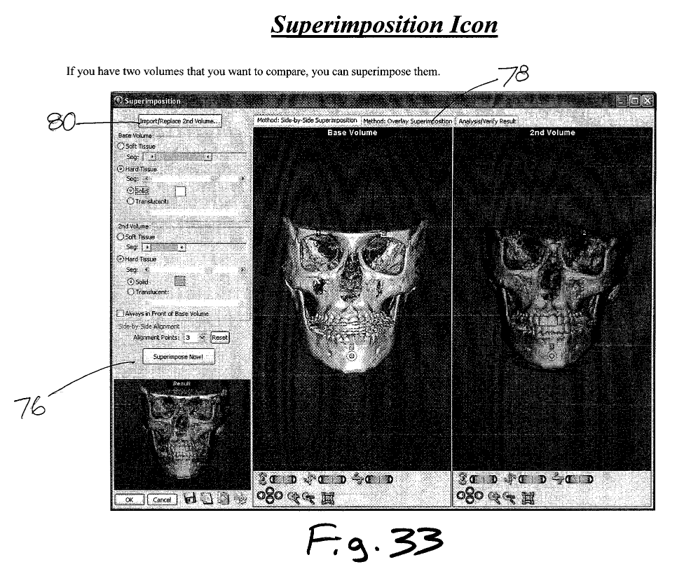

Also shown in FIG. 6 is an “Airway/Sinus” icon button 64 which, when selected, brings up the sinus/airway screen 72 seen in FIG. 32 on the module 10. The sinus/airway screen 32 allows users to mark a patient's airway, view it in three dimensions, calculate the airway volume, and locate the cross-section where its area is the smallest. The viewer may accomplish these tasks by following the simple step by step instructions 74 provided on the sinus/airway screen 32. It is to be expressly understood that the instructions 74 given in the figure are for illustrative purposes and that fewer, additional, or different instructions may be given without departing from the original spirit and scope of the invention.

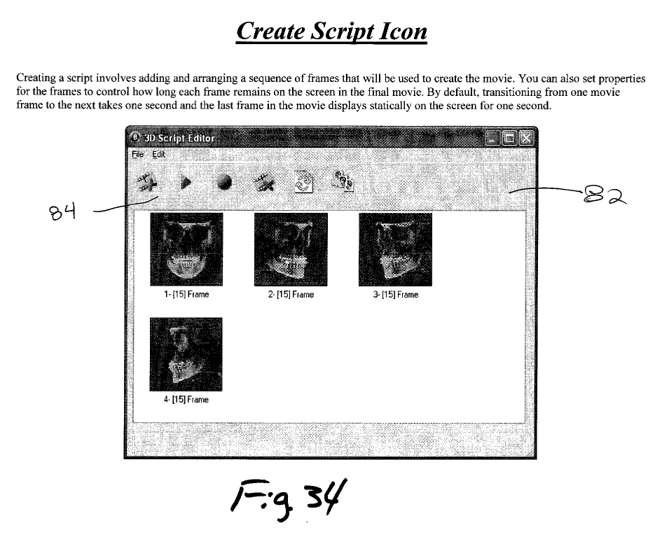

Also shown in FIG. 6 is a “Superimposition” icon button 66 which, when selected, brings up the superimposition screen 76 shown in FIG. 33. Here the viewer is allowed to compare two different three dimensional volumes, namely a base volume currently being worked on and a previously saved second volume retrieved from the database. The viewer may superimpose them either side by side as seen in FIG. 33 or by overlaying them by selecting an overlay superimposition button 78. The second volume may be changed by selecting an import/replace second volume button 80 which then allows the user to select or upload an additional or different second volume to superimpose with the original base volume.

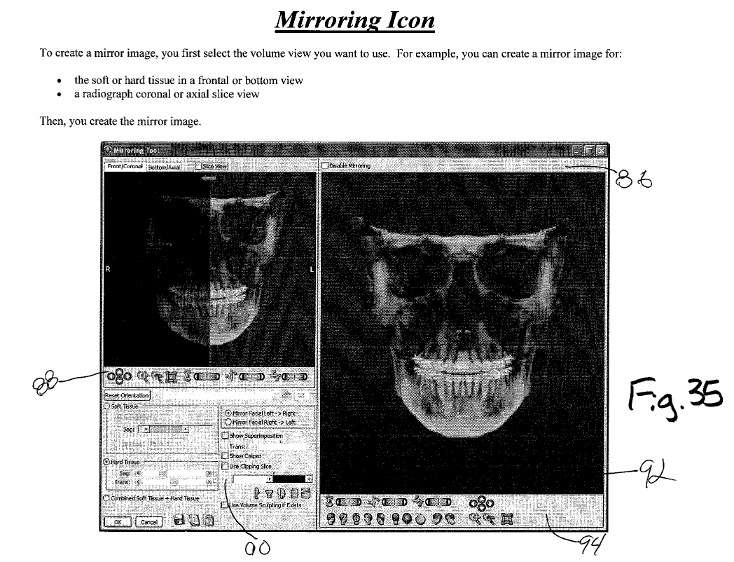

Also shown in FIG. 6 is a “Create Script” icon button 68 which, when selected, brings up the 3D script editor screen 82 as seen in FIG. 34. The 3D script editor screen 82 allows the viewer to add and arrange a sequence of previously saved three dimensional image frames into a movie. The viewer may set properties for the frames to control how long each frame remains on the screen in the final movie using an editing toolbar 84 within the 3D script editor screen 82. By default, transitioning from one movie frame to the next takes one second and the last frame in the movie displays statically on the screen for one second.

Also shown in FIG. 6 is a “Mirroring” icon button 70 which, when selected, brings up a mirroring tool screen 86 as seen in FIG. 35. Here the viewer is allowed to create a mirror image for a specific three dimensional image. First the viewer selects the view to use by manipulating a tool bar 88 as previously described above. Once the view is set, the point at which the mirror is taken from is set by a mirror option palette 90 which operates in much the same manner as the radiograph setup palette 40 for the building of x-rays as described above. The mirror image that is created is then displayed in the mirror window 92. The mirror window 92 may then be further manipulated in any manner seen fit by the use of another manipulation toolbar 94.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method of selectively generating graphic medical records from a three dimensional database of a patient's anatomy stored in a computer comprising:
selecting a starting three dimensional data set representative of a starting view from the three dimensional data base;
selecting a portion of the starting three dimensional data set within a defined window of viewing focus as displayed in a user selected starting view;
automatically selecting a plurality of viewing axes;
automatically varying the portion of the starting three dimensional data set which is selected within the defined window of viewing focus to produce smoothly sequenced successive portions of the three dimensional data set within the defined window of viewing focus along each one of the plurality of viewing axes as displayed in corresponding moving views;
for each viewing axis, selectively stopping the production of smooth sequenced successive portions of the three dimensional data set within the defined window of viewing focus at a selected one of the smooth sequenced successive portions of the three dimensional data set in the defined window focus as displayed in a corresponding stopped view; and
for each viewing axis, selectively recording the selected one of the smooth sequenced successive portions of the three dimensional data set within the defined window of viewing focus as displayed in a corresponding recorded view.

2. The method of claim 1 further comprising for each viewing axis, rotating, translating or magnifying the selected portion of the three dimensional data set within the defined window of viewing focus prior to the recording of the selected portion of the three dimensional data set within the defined window of viewing focus as displayed in a corresponding rotated, translated or magnified view.

3. The method of claim 1 further comprising for each viewing axis, resuming varying to completion the portion of the starting three dimensional data set defined within the defined window of viewing focus to produce smoothly sequenced successive portions of the three dimensional data set within the defined window of viewing focus as displayed in corresponding resumed moving views after recording the selected portion of the three dimensional data set within each viewing axis as displayed in the corresponding recorded view.

4. The method of claim 1 further comprising generating a two dimensional x-ray image for each viewing axis and selectively recording the generated x-ray image.

5. The method of claim 1 where selecting a starting three dimensional data set representative of a starting view comprises selecting a starting three dimensional data set representative of a starting view from a plurality of pre-determined starting three dimensional data sets, each corresponding to a different predetermined starting view.

6. The method of claim 1 where automatically selecting a plurality of viewing axes comprises automatically progressing though a sequence of pre-selected default viewing axes.

7. The method of claim 1 where automatically selecting a plurality of viewing axes comprises automatically progressing through a sequence of viewing axes as defined by a user.

8. The method of claim 1 where automatically selecting a plurality of viewing axes comprises automatically progressing through a sequence of randomly selected viewing axes.

9. The method of claim 1 where selectively recording for each viewing axis the selected portion of the three dimensional data set within the defined window of viewing focus comprises recording the selected portion of the three dimensional data set within the defined window of viewing focus in an internal memory storage database within the computer or to an external and removable memory storage device.

10. The method of claim 1 further comprising returning to the first viewing axis after the varying along each of the viewing axes have been completed and repeating the varying of each of the viewing axes in a continuous loop until stopped by a user.

11. An apparatus for selectively generating graphic medical records from a three dimensional database of a patient's anatomy stored in a computer comprising:
means for selecting a starting three dimensional data set representative of a starting view from the three dimensional database;
means for selecting a portion of the starting three dimensional data set within a defined window of viewing focus for display in a corresponding starting view;
means for automatically selecting a plurality of viewing axes;
means for automatically varying the boundaries of the three dimensional data set within the defined window of viewing focus to produce smoothly sequenced contiguous portions of the three dimensional data set within the defined window of viewing focus along each one of the plurality of viewing axes for display in a corresponding moving view;
for each viewing axis, means for selectively stopping varying the production of smooth sequenced contiguous portions of the three dimensional data set within the defined window of viewing focus at a selected one of the smoothed sequence of contiguous portions of the three dimensional data set within the defined window of viewing focus for display in a corresponding stopped view; and
for each viewing axis, means for selectively recording the selected one of the smoothed sequence of contiguous portions of the three dimensional data set within the defined window of viewing focus for display in a corresponding recorded view.

12. The apparatus of claim 11 further comprising for each viewing axis, means for rotating, translating or magnifying the selected portion of the three dimensional data set within the defined window of viewing focus prior to the recording of the selected portion of the three dimensional data set within the defined window of viewing focus for display in a corresponding rotated, translated or magnified view.

13. The apparatus of claim 11 further comprising for each viewing axis, means for resuming varying to completion the portion of the starting three dimensional data set defined within the defined window of viewing focus to produce smoothly sequenced successive portions of the three dimensional data set within the defined window of viewing focus for display in corresponding resumed moving views after recording the selected portion of the three dimensional data set within the defined window of viewing focus.

14. The apparatus of claim 1 further comprising means for generating a two dimensional x-ray image for each viewing axis and means for selectively recording the generated x-ray image.

15. The apparatus of claim 11 where the means for selecting a starting three dimensional data set representative of a starting view from the three dimensional database comprises means for selecting a starting three dimensional data set representative of a starting view from a plurality of pre-determined starting three dimensional data sets, each corresponding to a different predetermined starting view.

16. The apparatus of claim 14 where the means for automatically selecting a plurality of viewing axes comprises means for automatically progressing though a sequence of pre-selected default viewing axes.

17. The apparatus of claim 14 where the means for automatically selecting a plurality of viewing axes comprises means for automatically progressing through a sequence of viewing axes as defined by a user.

18. The apparatus of claim 14 where the means for automatically selecting a plurality of viewing axes comprises means for automatically progressing through a sequence of randomly selected viewing axes.

19. The apparatus of claim 11 where for each viewing axis, the means for selectively recording the selected portion of the data set within the defined window of viewing focus comprises an internal memory or an external and removable memory device capable of recording a selected portion of the data set within the defined window of viewing focus and recorded instructions for controlling a computer to render the selected portion of the data set into the corresponding recorded display.

20. The apparatus of claim 11 further comprising means for returning to the first viewing axis after the varying of each of the viewing axes have been completed and means for repeating the varying of each of the viewing axes in a continuous loop until stopped by a user.
